(19) United States
(12) Patent Application Publication
(10) Pub. No.: US 2002/0174749 A1
(43) Pub. Date: Nov. 28, 2002

(54) Drywall tool having a screwdriver adapter

(76) Inventor: Robert W. Clemons, Evansville, IN (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/154,697

(22) Filed: May 24, 2002

Related U.S. Application Data
(60) Provisional application No. 60/293,242, filed on May 24, 2001.

(51) Int. Cl. B25G 1/08

(52) U.S. Cl. 81/490

(57) ABSTRACT

A drywall tool for applying drywall mud during the installation of drywall, and including a bit storage cavity for receiving a screwdriver bit to turn the head of the screw below the surface of the drywall when necessary. The tool includes a handle, a blade attached to one end of the handle, and a bit storage cavity disposed at the opposite end of the handle. Said bit storage cavity includes an opening, and an inner chamber accommodated with a number of ribs formed on the interior of the inner chamber. Said bit storage cavity sized to slidably receive said screwdriver bit.

Use of the drywall tool of the present invention allows the workman to apply the drywall mud with the blade portion of the tool, and when a screwdriver is necessarily needed to turn the head of the drywall screw below the surface of the drywall, the workman simply turns the drywall tool of the present invention around 180 degrees in their hand and rotates the drywall screw using the screwdriver tip projecting from the bit storage cavity. Once the head of the drywall screw projects below the surface of the drywall, the workman again rotates the tool 180 degrees and continues applying the drywall mud using the blade portion.

### CROSS REFERENCES TO RELATED APPLICATIONS

U.S. Provisional Application for Patent No. 60/293,242, filed May 24, 2001, with title, “Better way” which is hereby incorporated by reference. Applicant claims priority pursuant to 35 U.S.C. Par. 119(e) (i).

Statement as to rights to inventions made under Federally sponsored research and development: Not Applicable

### BACKGROUND OF THE INVENTION

1. Field of the Invention

This invention relates to a drywall tool, and more particularly, a drywall knife having a screwdriver adapter, said screwdriver adapter portion of the drywall tool for rotating drywall screws when installing the drywall, and said knife portion for applying the drywall mud thereto.

2. Brief Description of Prior Art

Tools are a necessary and essential asset of any tradesman. Having the proper and most efficient tool for a given task can result in an enormous cumulative reduction in manhours, materials, and thus, costs. One particular trade in which the preferred embodiment of the present invention can be utilized is the installation of gypsum wallboard or “drywall” panels. Typically, sheets of drywall are fastened to wooden studs using drywall nails or screws. Seams between the drywall sheets must be taped over, and the nail or screw heads must be coated with mastic material to form a continuous wall surface. The task of applying drywall tape and mastic drywall mud is generally laborious, tedious, and messy. Although inventions have made the task easier, improvement is still needed.

As stated, sheets of drywall are typically nailed or screwed in place. Drywall screws are generally preferred to nails because screws, unlike nails, do not back out over time, and are usually driven into the drywall such that the screw head is slightly below the surface of the drywall. The drywall mud is then applied over the head of the screw to cover the same utilizing the drywall knife. However, occasionally, the head of the drywall screw projects above the surface of the drywall and must be turned to move the head of the screw below the surface of the drywall before applying the mud.

It is typical for a workman to first install the sheets of drywall using drywall screws and a screwdriver as described above, and then once the drywall is installed, apply the drywall mud using a conventional drywall knife. During the application of the drywall mud, occasionally, the workman will find the head of a drywall screw projecting above the surface of the drywall and must be turned to move the head of the screw below the surface of the drywall. The workman is then required to temporarily replace the conventional drywall knife with the screwdriver in order to rotate the drywall screw. Once the screw head is below the surface of the drywall, the workman may then proceed with applying the drywall mud with the drywall tool. Obviously, temporary replacement of the drywall knife with the screwdriver, and then again replacement of the screwdriver with the drywall knife, is inefficient, and results in lost manhours, and thus, costs.

It is known to provide a drywall knife having a screwdriver adapter which is embedded within the handle of the knife. The designs of the prior art are generally inefficient when applying a rotational force to rotate the drywall screw.

U.S. Pat. No. 5,720,063 (Chacon) discloses a drywall knife most similar to the present invention, having a handle with one end attached to the blade of the knife, and the opposite end of the handle having a distal end defined by a metal end cap. Said distal end having a recess for receiving a screwdriver tip therein, and a dimple forming projection disposed generally coaxially about the screwdriver tip. Said dimple forming projection design resulting in increased manufacturing costs of the drywall tool. This is a relatively costly, and uneconomical means of achieving the particular objective of the present invention.

The entire handle of the present invention is preferably integrally molded, normally of a rigid plastic material. This molded construction makes the tool of the present invention economical, and more durable than the tool of Chacon.

As will be seen from the subsequent description, the preferred embodiments of the present invention overcome these and other shortcomings of prior art.

### SUMMARY OF THE INVENTION

The present invention is designed to provide during the installation of drywall, a drywall tool for applying the drywall mud, and having a bit storage cavity for receiving a screwdriver bit to turn the head of the screw below the surface of the drywall when necessary. The tool includes a handle, a blade attached to one end of the handle, and a bit storage cavity disposed at the opposite end of the handle. Said bit storage cavity sized to receive a screwdriver bit. Use of the drywall tool of the present invention allows the workman to apply the drywall mud with the blade portion of the tool, and when a screwdriver is necessarily needed to turn the head of the drywall screw below the surface of the drywall, the workman simply turns the drywall tool of the present invention around 180 degrees in their hand and rotates the drywall screw using the screwdriver tip projecting from the bit storage cavity. Once the head of the drywall screw projects below the surface of the drywall, the workman again rotates the tool 180 degrees and continues applying the drywall mud using the blade portion.

### BRIEF DESCRIPTION OF THE DRAWINGS

FIG. 1 is perspective view of the preferred embodiment of the present invention, a drywall tool having a screwdriver adapter.

FIG. 2 is a side view taken along line A-A shown in FIG. 1.

FIG. 3 is an exploded perspective view of a bit storage cavity disposed at one end of the handle portion of the drywall tool shown in FIG. 1.

FIG. 4 is a perspective view of a screwdriver bit.

### DESCRIPTION OF THE PREFERRED EMBODIMENT

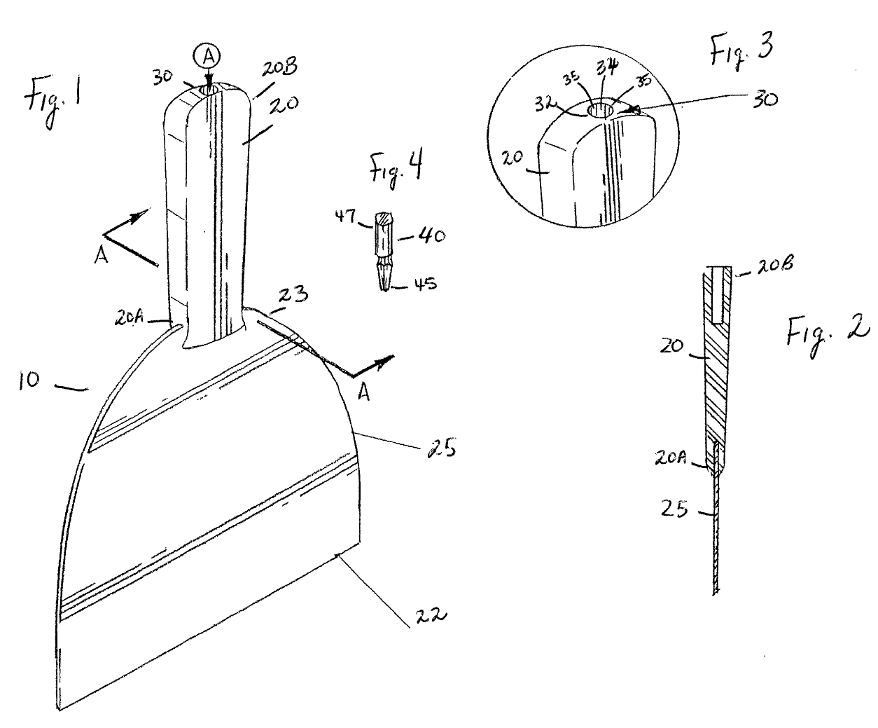

FIGS. 1-4 illustrate a preferred embodiment of a drywall tool having a screwdriver adapter 10 made in accordance with the present invention. As shown in FIG. 1, the drywall tool 10 includes a handle portion 20 having a first end 20A and a second end 20B opposite the first end 20A, a blade 25 attached to the first end 20A of the handle 20, and a bit storage cavity 30 for receiving a screwdriver bit 40, said bit storage cavity 30 disposed on the second end 20B of the handle 20. The handle 20 is preferably made from a rigid plastic material, while the blade 25 is integrally formed from a metal material, such as stainless steal.

The blade 25 having an application-edge 22 suitable for applying the drywall mud and an opposite end 23 attached to the first end 20A of the handle 20. Said handle 20 being non-movably attached to the approximate midway of the opposite end 23 of the blade 25, so that the application-edge 22 of the blade 25 is perpendicular to the longitudinal axis of the handle 20. Operation of the handle 20 and blade 25 of the drywall tool 10 for applying drywall mud, as will be discussed, is known in the art. Further, the shape and size of the blade 25 may be of any shape and size suitable for applying drywall mud.

Disposed at the approximate midway of the second end 20B of the handle 20 is said bit storage cavity 30, said bit storage cavity 30 sized to receive said screwdriver bit 40 therein. As best shown in FIG. 3, said bit storage cavity 30 having an opening 32 and an inner chamber 34, said inner chamber 34 accommodated with a number of ribs 35 formed on the interior surface of the inner chamber 34. Said ribs 35 are parallel both to each other and to the longitudinal axis of the handle 20. In the preferred embodiment, the opening 32 and the inner chamber 34 having a generally cuboid configuration. Said opening 32 and said inner chamber 34 with said ribs 35 may be formed as part of the step of manufacturing the handle 20.

Referring to FIG. 4, said screwdriver bit 40 having a tip-end 45 and an adapter-end 47 opposite the tip-end 45, said adapter-end 47 preferably having a cuboid configuration, sized and shaped in slidably mating relationship with the inner chamber 34, specifically the number of ribs 35 within the inner chamber 34. When the adapter-end 47 of the screwdriver bit 40 is installed within the bit storage cavity 30 of the handle 20, as will be further discussed, the adapter-end 47 fits within the inner chamber 34 in mating relationship so that the inner chamber 34 retains the adapter-end 47 in frictional relationship therein. In the preferred embodiment, the tip-end 45 of the screwdriver bit 40 having a phillips head tip configuration, however other tip configurations may be used.

The screwdriver bit 40 is installed in the bit storage cavity 30 of the handle 20 by aligning the adapter-end 47 with the ribs 35 of the inner chamber 34 and slidingly asserting the adapter-end 47 of the screwdriver bit 40 within the bit storage cavity 30 in the direction of Arrow A in FIG. 1. When installed, the tip-end 45 of the screwdriver bit 40 projects outwardly from the handle 20 so that the axis of the screwdriver bit 40 is parallel to the longitudinal axis of the handle 20. The screwdriver bit 40 is removed from the bit storage cavity 30 by separating the screwdriver bit 40 from the bit storage cavity 30 in a direction opposite to Arrow A in FIG. 1.

When installing drywall, it is typical for a workman to first install the sheets of drywall with drywall screws using a screwdriver. Once the drywall is installed, the workman applies the drywall mud as described in the BACKGROUND OF THE INVENTION section. When applying the drywall mud, occasionally, the head of the drywall screw projects above the surface of the drywall and must be turned to move the head of the screw below the surface of the drywall as described in the BACKGROUND OF THE INVENTION section. The workman is then required to use the screwdriver in order to rotate the drywall screw. Once the screw head is below the surface of the drywall, the workman may then proceed with applying the drywall mud.

Use of the present invention allows the workman to apply the drywall mud with the blade 25 portion of the drywall tool 10. When a screwdriver is needed to turn the head of the drywall screw below the surface of the drywall, the workman simply turns the drywall tool 10 around 180 degrees in the workman's hand (not shown) and rotates the drywall screw using the tip-end 45 of the screwdriver bit 40. Once the head of the drywall screw projects below the surface of the drywall, the workman again turns the drywall tool 10 around 180 degrees in the workman's hand and continues applying the drywall mud using the blade 25 portion.

The invention is thus described with respect to a phillips head bit configuration, since the phillips head bit is very common and is generally an important element when installing drywall screws. This is purely by way of example and not of limitation. As such, it should be obvious that other bit configurations may be used.

In accordance with these and other possible variations and adaptations of the present invention, the scope of the invention should be determined in accordance with the following claims and their legal equivalents, and not solely in accordance with that embodiment within which the invention has been taught.

I claim:

1. A drywall tool comprising:
a handle portion having a first end and a second end opposite the first end;
a blade attached to the first end of the handle portion;
a bit storage cavity disposed at the approximate midway of the second end of the handle, said bit storage cavity including an inner chamber, said inner chamber having a number of ribs formed on the inner surface of the inner chamber; and
a screwdriver bit having a tip-end and an adapter-end opposite the tip-end, said adapter-end sized and shaped in slidably mating relationship with the inner chamber of the bit storage cavity.

2. A drywall tool as recited in claim 1, wherein said ribs are parallel both to each other and to the longitudinal axis of the handle portion.

3. A drywall tool as recited in claim 1, wherein the inner chamber of the bit storage cavity having a generally cuboid configuration.

4. A drywall tool as recited in claim 1, wherein said tip-end of the screwdriver bit having a phillips head tip configuration.

5. A tool for storing a screwdriver bit, said tool comprising:
a handle portion;
a bit storage cavity disposed at the approximate midway of one end of the handle portion, said bit storage cavity including an inner chamber, said inner chamber having a number of ribs formed on the inner surface of the inner chamber; and
said screwdriver bit having a tip-end and an adapter-end opposite the tip-end, said adapter-end sized and shaped in slidably mating relationship with the inner chamber of the bit storage cavity.

6. A tool for storing a screwdriver bit as recited in claim 1, wherein said ribs are parallel both to each other and to the longitudinal axis of the handle portion.

7. A tool for storing a screwdriver bit as recited in claim 1, wherein the inner chamber of the bit storage cavity having a generally cuboid configuration.

8. A tool for storing a screwdriver bit as recited in claim 1, wherein said tip-end of the screwdriver bit having a phillips head tip configuration.
